(19) United States
(12) Patent Application Publication
(10) Pub. No.: US 2026/0235256 A1
(43) Pub. Date: Aug. 13, 2026

(54) METHOD FOR CONTROLLING THE INTERNAL PRESSURE OF A CRYOGENIC TANK

(71) Applicant: Alfa Laval Switzerland AG, Allschwil (CH)

(72) Inventors: Félicien GEBEL, Allschwil (CH); Pierre-Yves DUVIVIER, Allschwil (CH)

(21) Appl. No.: 19/124,652

(22) PCT Filed: Oct. 27, 2023
(86) PCT No.: PCT/EP2023/080089

§ 371 Date: Apr. 29, 2026

(30) Foreign Application Priority Data
Nov. 2, 2022 (FR) FR2211414

(51) Int. Cl. F17C 1/00

(52) U.S. Cl. CPC F17C 1/00; F17C 2205/0323; F17C 2221/012; F17C 2223/0161; F17C 2223/035; F17C 2227/0157; F17C 2250/0626

(57) ABSTRACT

The invention relates to a method for controlling the internal pressure of a cryogenic tank (100) containing a liquid fraction (1002) and a gaseous fraction (1004) of a fluid, the enthalpy of which can be lowered during isothermal compression in the liquid phase.

### TECHNICAL FIELD OF THE INVENTION

The invention belongs to the technical field of cryogenic tanks. The invention relates more specifically to a method for controlling the internal pressure of a cryogenic tank. The invention also relates to a facility for storing a cryogenic fluid.

A cryogenic tank is any tank suitable and designed for storing gases in liquefied form.

A cryogenic fluid is any fluid that has been cooled to a temperature less than its boiling point.

### TECHNICAL BACKGROUND

The invention is particularly applicable to cryogenic tanks suitable for storing a cryogenic fluid at a pressure of less than 20 bar. The pressure indicated herein and the pressures indicated subsequently are in absolute bars.

Such tanks are commonly used to store cryogenic fluid, which, at atmospheric pressure, is liquid at a temperature of less than 273.15 K, in particular less than 213.15 K. Typically, these tanks belong to a storage facility.

These storage facilities are generally configured, on the one hand, to enable fluid to be distributed to one or more requesting elements, and on the other hand, to be supplied with fluid from one or more external supply elements.

For example, requesting elements include elements capable of receiving fluid from a tank. For example, these elements can be vehicles configured to receive and store fluid.

For example, external supply elements include elements capable of supplying a tank with a quantity of fluid in liquid or gaseous form.

In such storage facilities, the cryogenic fluid is initially stored in a liquid state but inevitably develops boil-off gas, so as to form in the tank, both a liquid fraction at the bottom of the tank and a gaseous fraction at the top of the tank. Part of this gaseous fraction from the boil-off gas is usually vented to the atmosphere without being used. Typically, this evacuation is made possible by a protective member in the tank such as a valve and/or a rupture disc which releases at least part of the gaseous fraction outwardly in the event of pressure exceeding a limit in the tank. This limit is typically the maximum permissible pressure of the tank, the limit usually specified by the manufacturer.

However, the boil-off gas released into the atmosphere constitutes both an ecological and an economic disadvantage.

This is why various systems and methods for managing the pressure inside a tank have been devised to prevent this boil-off gas from being evacuated outwardly. These systems and methods consist either in consuming a portion of the liquid fraction contained in the tank so as to regularly lower the internal pressure of the tank, or in extracting part of the gaseous fraction from the tank and recompressing it via a complex and costly gas compression system.

However, for obvious ecological and economic reasons, such solutions cannot be envisaged for commercial applications at storage facilities.

One aim of the present invention is therefore to overcome some or all of the drawbacks identified hereinbefore.

### SUMMARY OF THE INVENTION

To this end, the invention proposes a simple, inexpensive method for controlling the internal pressure of a cryogenic tank so as to prevent at least part of the gaseous fraction from being evacuated from the cryogenic tank as a result of too great a rise in its internal pressure.

To this end, a method is first proposed for controlling the internal pressure of a cryogenic tank containing a liquid fraction and a gaseous fraction of a fluid, the enthalpy of which can be lowered during isothermal compression in the liquid phase, the method comprising the following steps:
withdrawal of a portion of the liquid fraction to obtain a withdrawn portion defined in state A by:
a first temperature T1,
a first pressure P1,
a first enthalpy E1, and
a first density D1,
substantially isothermal compression of the withdrawn portion to obtain a compressed portion defined in state B by:
a second temperature T2 substantially equal to the first temperature T1,
a second pressure P2 greater than the first pressure P1, and
a second density D2 greater than the first density D1, said compression being intended to lead to a decrease in enthalpies between the first enthalpy E1 of state A and a second enthalpy E2 of state B,
expansion of the compressed portion to obtain an expanded portion defined in state C by:
a third temperature T3 less than the second temperature T2,
a third pressure P3 less than the second pressure P2, and
a third density D3 less than the second density D2 and greater than the first density D1,
injection of the compressed portion or of the expanded portion into the storage tank,
   said expansion being performed during or after the injection step when the compressed portion is injected into the tank, or
   said expansion being carried out between the compression step and the injection step when the expanded portion is injected into the tank.

The method according to the invention makes it possible to counteract an increase in the internal pressure of the cryogenic tank caused naturally by its ambient environment. Thus, evacuation of part of the gaseous fraction from the tank, for example by actuating a safety valve or through the walls of the cryogenic tank, is avoided.

Various additional features can be provided alone or in combination:
the compression step leads to a continuous decrease in the enthalpy of the withdrawn portion from state A to state B,
the compression step is stopped when the decrease in enthalpy of the compressed portion is less than 0.1 kJ/kg for a pressure rise of 1 bar,
the fluid is hydrogen,
the third pressure P3 is greater than or substantially equal to the first pressure P1,
the expansion is a substantially isenthalpic expansion when it takes place between the compression step and the injection step.

Secondly, a facility for storing a liquid fraction and a gaseous fraction of a fluid configured to implement the above-described method is proposed, the facility comprising:
a cryogenic tank intended to contain the fluid,
a means of withdrawing a portion of the liquid fraction,
a compressor means comprising a compressor element and a cooling element for the compressor element configured to maintain the compressor element at temperature during compression to achieve substantially isothermal compression of the withdrawn portion to obtain a compressed portion,
an expansion means capable of expanding the compressed portion to obtain an expanded portion, and
an injector means capable of injecting the compressed portion or the expanded portion into the cryogenic tank, a facility wherein the expansion means and the tank are either combined or separate.

The facility according to the invention has the advantage of being compact and easy to implement. Additionally, the facility is composed solely of simple and low-cost components.

Various additional features can be provided alone or in combination:
the facility further comprises a buffer tank arranged between the compressor means and the expansion means,
the expansion means comprises a throttle valve.

The invention may also relate to any alternative method or device comprising any combination of the above or below features.

### BRIEF DESCRIPTION OF THE FIGURES

Further features and advantages of the invention will become apparent from reading the following detailed description, for the understanding of which reference is made to the appended drawings in which:

FIG. 1 is a schematic depiction of a storage facility according to a first example embodiment of the invention.

FIG. 2 is a schematic depiction of a storage facility according to a second example embodiment of the invention.

FIG. 3 is a schematic depiction of a storage facility according to a third example embodiment of the invention.

FIG. 4 is a diagram showing the change in enthalpy (in kJ/kg) based on the pressure (in bar) of part of a liquid hydrogen fraction extracted from a tank of a storage facility according to the invention.

FIG. 5 is a diagram showing the change in the Joule-Thomson coefficient (in K/bar) based on the temperature (in K) for different pressures of part of a liquid hydrogen fraction extracted from a tank of a storage facility according to the invention.

FIG. 6 is a schematic depiction of an example of a compressor means for use in a storage facility according to an example embodiment of the invention.

### DETAILED DESCRIPTION OF THE INVENTION

In the following description, identical, similar or analogous elements will be designated by the same alphanumeric references.

The storage facility of the example embodiments of the invention described below comprises a tank 100 for storing fluid and notably a two-phase mixture of liquid and gas.

The tank 100 is a cryogenic tank.

The fluid is a cryogenic fluid.

The tank 100 contains the fluid at a storage pressure greater than atmospheric pressure, for example at a pressure of less than 20 bar, preferably less than 12 bar. The tank 100 is preferably configured to store a volume of fluid of up to 50,000 L at an equilibrium temperature of between 3.15 K and 213.15 K, preferably between 18.15 K and 73.15 K.

The fluid suitable for being stored in the tank 100 is a fluid, the enthalpy of which can be lowered during isothermal compression in the liquid phase. For example, the fluid may be helium or hydrogen. The suitable fluid can be defined by an enthalpy curve at constant temperature of the liquid fluid which has a substantially parabolic shape with an inflection point. The inflection point is reached when the Joule-Thomson coefficient characteristic of the liquid phase of the fluid is equal to zero. Note that the inflection point of the enthalpy curve varies with temperature.

Advantageously, the fluid is hydrogen. It is noted that the temperature of liquid hydrogen is less than 33.15 K at atmospheric pressure.

For the purposes of the present invention, hydrogen means para-hydrogen, ortho-hydrogen or a mixture of the two.

The tank 100 is preferably double-shelled, comprising a first inner shell intended to contain the fluid. In this way, the tank 100 has optimized thermal insulation to minimize heat exchange between the outside of the tank 100 and the fluid.

The first shell is preferably surrounded by a second shell and the tank 100 comprises thermal insulation in the space between the two shells (notably a vacuum space).

The fluid contained in the first shell of the tank 100 forms a liquid fraction 1002 at the lower part, i.e. at the bottom of the tank 100, and a gaseous fraction 1004 at the upper part, i.e. at the top of the tank 100, separated by an upper surface from the liquid fraction 1002.

Typically, the tank 100 may comprise a protective member such as a valve and/or a rupture disc allowing fluid to be released outwardly in the event of pressure exceeding a limit in the first shell. This limit is typically the maximum permissible pressure of the tank 100 (given by the manufacturer). However, the purpose of the invention is to prevent this protective member from being activated, as it is only present in the event of an extreme emergency, in particular if the method according to the invention malfunctions.

Preferably, the tank 100 further comprises one or more means for measuring a parameter representative of the fluid pressure inside the first shell of the tank 100. For example, a pressure gage, an electronic pressure sensor or any other means for measuring a parameter representative of the pressure of a fluid known to the person skilled in the art can be used as a measuring means.

This tank 100 is further adapted to supply one or more requesting elements with liquid preferably from part of the liquid fraction 1002 extracted from the bottom of the tank 100 (requesting elements not shown in the figures).

The tank 100 may therefore further comprise a supply line arranged to supply at least part of the liquid fraction 1002 contained in the tank 100 downstream to at least one requesting element.

The supply line may comprise a vaporizer, or heater, and at least one valve to supply vaporized gas downstream rather than directly to at least part of the extracted liquid fraction 1002. This heater can be a heat exchanger used to transform at least part of the liquid fraction 1002 drawn from the tank 100 into gas by exchange with the ambient atmosphere.

This tank 100 is also typically adapted to be supplied with fluid from one or more external supply elements (external supply elements not shown in the figures).

The tank 100 may therefore further comprise a supply circuit for the first shell (supply circuit not shown in the figures).

For example, this supply circuit comprises a first supply line having an upstream end intended to be connected to a first fluid source (such as a hose from a container transported by a truck, for example) and a downstream end connected to the lower part of the first shell of the tank 100.

The supply circuit may comprise a second supply line having an upstream end intended to be connected to a second fluid source and a downstream end connected to the upper part of the first shell of the tank 100.

The upstream ends of the first and second supply lines can be configured to be simultaneously connected to the same fluid source, for example at a common inlet or flange. In this case, the first and second fluid sources are combined.

The upstream ends of the first and second supply lines can also each be configured for simultaneous connection to different fluid sources. In this case, the first and second fluid sources are separate.

The supply circuit may comprise a set of distribution valve(s) configured to allow fluid from the fluid source(s) to be distributed in either of the first or second supply lines.

It should be noted that, when supplying the tank 100, any input of heat into the tank 100 will cause partial vaporization of the liquid fraction 1002 of the fluid, resulting in an increase in the volume of the gaseous fraction 1004.

The storage facility further comprises a means 1006 for withdrawing a portion of the liquid fraction 1002 which is at least partly connected to the tank 100 in order to obtain a portion of the liquid fraction. The withdrawal means 1006 is capable and configured to ensure that the extraction of a portion of the liquid fraction 1002 is always effective regardless of the level of the liquid fraction 1002 in the tank 100. To this end, the withdrawal means 1006 comprises an extraction line Cext having an upstream end connected to the first shell, in particular to its lower part, and configured to allow the extraction of a portion of the liquid fraction 1002 contained in the first shell outwardly of the tank 100, in particular to other elements of the storage facility, as soon as the internal pressure of the tank reaches a predetermined value. For example, for this purpose, the withdrawal means 1006 may further comprise a pilot valve to enable extraction to be activated or deactivated based on the internal pressure of the tank 100.

Preferably, the storage facility also comprises elements for measuring the temperature and the pressure of the extracted portion of the liquid fraction. For example, these measuring elements can be sensors known from the prior art.

The storage facility further comprises a compressor means 120.

In an example embodiment such as that shown in [FIG. 6], the compressor means 120 is a compression equipment 200 which contains a compressor element 210 configured to perform the compression and a cooling element 220 for the compressor element 210 which has the effect of cooling the compressor element 210 during the implementation of the compression, i.e. maintaining the compressor element 210 at temperature by avoiding its overheating. This enables the compression equipment 200 to perform a substantially isothermal compression of the portion of the liquid fraction 1002 extracted from the tank 100 by the withdrawal means 1006, in particular extracted by the extraction line Cext. In other words, the temperature of the portion of the liquid fraction entering the compression equipment 200 is approximately equal to that of the compressed portion leaving the compression equipment 200.

The compression equipment 200 is preferably configured to compress the portion of the extracted liquid fraction to a pressure of between 6 and 100 bar, at a temperature of between 18.15 K and 43.15 K. When the fluid is hydrogen, this pressure is preferably between 6 and 70 bar, or even between 6 and 40 bar, and at a temperature, preferably between 28.15 K and 33.15 K.

The advantage of this type of compression equipment 200 is that it combines the compression and cooling functions in a single device.

The compressor element 210 of the compression equipment 200 is preferably a piston-type pump, but can also be a gear, lobe, centrifugal pump or any other suitable pump configured to operate while immersed in a cryogenic liquid.

The cooling element 220 is preferably a device configured to cool the compressor element 210, in particular configured to cool the piston-type pump, during the achievement of its compression. Preferably, as shown in [FIG. 6], the cooling element 220 is a storage device defining an interior volume comprising a lower section 221 and an upper section 222. This interior volume contains a volume of the portion of the liquid fraction 1002 withdrawn, in particular that has been drawn in by the pump but has not yet passed therethrough and is therefore not yet compressed. The volume of the portion of the liquid fraction 1002 withdrawn contained in the storage device is sufficiently large to preferably cover the entire lower section 221 wherein the pump is located. In this way, the cold part of the pump is immersed in the volume of the portion of the liquid fraction 1002 that has been withdrawn, while its hot part, which notably comprises the drive shaft 211, is located outside this volume.

The storage device further comprises a line 223 for supplying the interior volume with the liquid fraction 1002 that has been withdrawn. The supply line 223 may be the extraction line Cext or may be a separate line connected to the extraction line Cext. The supply line 223 is then connected to the withdrawal means 1006 and opens into the lower section 221 of the interior volume, where a pump inlet E is preferably located. The pump inlet E is then arranged in contact with the bottom of the storage device, i.e. where the pressure is highest. The storage device also comprises an extraction line 212 connected to an outlet S of the pump through which the portion that has been compressed is extracted. For example, the extraction line 212 extends from the lower section 221 to the upper section 222 and opens outside the interior volume.

The storage device also comprises a degassing line 224 which opens into the upper section 222 of the interior volume.

In this example embodiment, the liquid fraction 1002 withdrawn, before passing through the pump, is used as a coolant and produces heat exchange through direct contact with the pump in order to maintain it at temperature during compression. Providing means for inducing heat exchange directly at the pump, rather than subsequently at the actual compressed portion, makes for compact and easy-to-use compressor means.

The effect of such a configuration is to have a compact compressor means 120 wherein the coolant corresponds to that which was initially present in the tank 100 and which has been withdrawn via the withdrawal means 1006. This results in obvious savings as there is no need to bring in coolant from outside.

In another example embodiment, the cooling element is a refrigeration unit configured to produce heat exchange with the compression element and wherein a coolant different from that used in the example described hereinbefore flows, and is suitable for cooling the compressor element during compression.

In another example embodiment, the cooling element is a jacket (or sleeve) arranged on the periphery of the compressor element and inside which part of the portion of the extracted liquid fraction 1002 flows. Thus, the part of the portion of the liquid fraction 1002 coming directly from the tank 100 and flowing through the jacket is defined by a temperature less than that of the liquid fraction being compressed. For example, 20% to 30% of the extracted liquid fraction flowing through the jacket. Preferably, after the part of the portion of the extracted liquid fraction has flowed through the jacket, it is reintroduced into the tank 100 at its bottom part. There are also clear cost savings as there is no need to bring in coolant from outside.

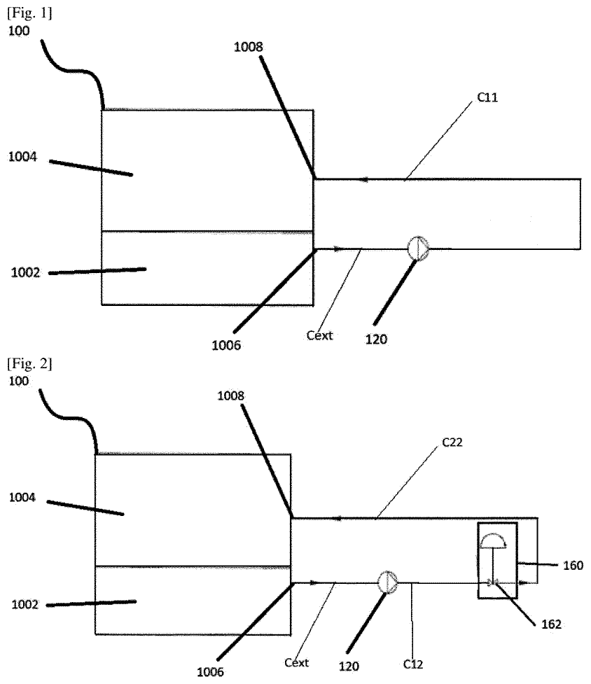

In a first example embodiment (example embodiment shown in [FIG. 1]), the compressor means 120 is connected downstream by a line C11 to injector means 1008 in the storage facility. The injector means 1008 is able to inject the compressed portion leaving the compressor means 120 into the tank 100.

In this first example embodiment, the compressor means 120, optionally associated with the external element, is suitable and configured to perform a substantially isothermal compression and to provide a compressed portion defined by a predetermined pressure, for example between 6 and 100 bar, preferably between 6 and 70 bar, when the fluid is hydrogen and at a temperature between 18.15 K and 43.15 K, preferably between 28.15 K and 33.15 K when the fluid is hydrogen. Pistons, gear pumps or else lobe pumps, for example, are suitable compressor means 120 for this first example embodiment.

The use of such a compressor means 120 has the advantage of avoiding expansion of the compressed portion before it is injected into the tank 100. Indeed, in this first example embodiment, the tank 100 acts as an expansion means. The tank is then configured to expand the compressed part injected into the tank 100 by the injector means 1008. This is made possible as in this case, the pressure difference between the compressed portion coming from the compressor means 120 and the internal pressure of the tank 100 does not exceed 70 bar. This is also made possible as in this case, the temperature of the compressed portion coming from the compressor means 120 and the internal temperature of the tank 100 are substantially equal.

In a second example embodiment (example embodiment shown in [FIG. 2]), the compressor means 120 is connected to an expansion means 160 by a line C12, with the expansion means 160 itself being connected to the injector means 1008 by another line C22. In other words, the expansion means 160 is connected upstream to the compressor means 120 and connected downstream to the injector means 1008. The combination of the compressor means 120 and the expansion means 160 notably makes it possible to control, or adjust, the pressure of the compressed portion obtained at the outlet of the compressor means 120. The compressor means 120, optionally associated with the external element, is suitable and configured to perform a substantially isothermal compression and to provide a compressed portion defined by a predetermined pressure, for example between 6 and 100 bar, preferably between 6 and 70 bar when the fluid is hydrogen, and at a temperature between 18.15 K and 43.15 K, preferably between 28.15 K and 33.15 K when the fluid is hydrogen. The expansion means is suitable and configured to perform a preferably isenthalpic expansion of the compressed portion and to provide an expanded portion defined by a predetermined pressure, for example less than 20 bar, preferably less than 12 bar when the fluid is hydrogen. Furthermore, the expansion means 160 is configured to perform a preferably isenthalpic expansion at a temperature between 3.15 K and 213.15 K, preferably between 18.15 K and 73.15 K when the fluid is hydrogen. To this end, the expansion means 160 comprises a valve. For example, the valve may be a disc valve or a porous orifice valve.

Advantageously, the expansion means 160 comprises a throttle valve 162. This throttle valve 162 enables the pressure of the compressed portion to be precisely regulated, and then the pressure of the compressed and then expanded portion to be adjusted. This throttle valve may, for example, be a Joule-Thomson valve.

In this second example embodiment, the pressure difference between the compressed portion coming from the compressor means 120 and the expanded portion coming from the expansion means 160 is preferably between 6 and 70 bar. In addition, the temperature of the compressed portion coming from the compressor means 120 is greater than that of the expanded portion.

In this second example embodiment, the injector means 1008 is then configured to inject into the tank 100 the expanded portion which has been previously compressed.

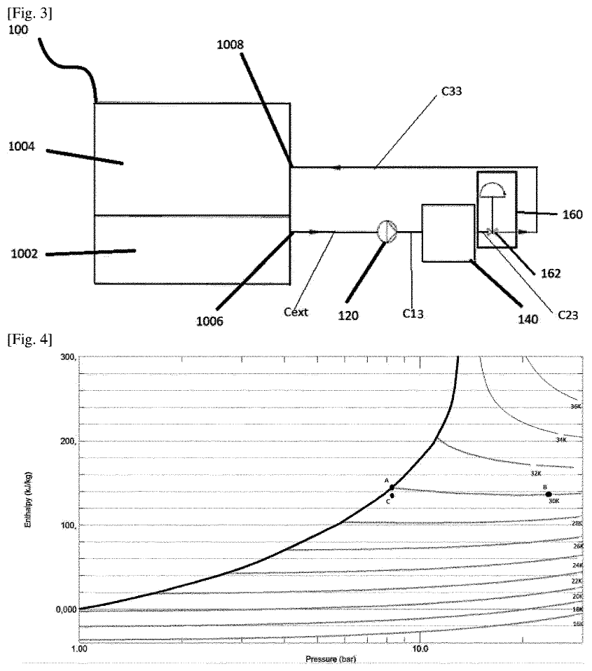

In a third example embodiment (example embodiment shown in [FIG. 3]), the storage facility notably comprises the compressor means 120, the expansion means 160 and the injector means 1008 of the second example embodiment and further comprises a buffer tank 140 upstream of which the compressor means 120 is connected by a first transfer line C13.

The buffer tank 140 is connected downstream, by a second transfer line C23, to the expansion means 160. The buffer tank 140 is therefore in particular arranged between the compressor means 120 and the expansion means 160.

This buffer tank 140 stores several volumes of compressed portions before performing an overall expansion in the expansion means 160 of these several volumes of compressed portions. To this end, the buffer tank 140 is configured to allow the volume contained therein to pass to the expansion means 160 once its internal pressure has reached a predetermined value, for example between 6 and 70 bar.

The injector means 1008 is connected to the expansion means 160 by a third transfer line C33. The injector means 1008 is capable of injecting the compressed then expanded portion leaving the expansion means 160 into the tank 100.

It should be noted that one or more of the lines included in this storage facility may be fitted with at least one specific valve and/or one regulating means capable of controlling the flow rate of fluid flowing therein.

In addition, one or more of the lines included in this storage facility advantageously comprise thermal insulation jackets (thermal insulation jackets not shown in the figures).

As noted above, it should be noted that the storage facility is in a closed cycle.

A method for controlling the internal pressure of the tank 100 included in the storage facility disclosed hereinbefore will now be disclosed below with reference to the different states wherein the portion of the liquid fraction withdrawn during the course of the method is found, in particular after each thermodynamic transformation (compression, expansion).

The tank 100 contains the fluid, preferably liquid hydrogen, forming the liquid fraction 1002 and the gaseous fraction 1004. Thus, in a preliminary step, a step of supplying the tank 100 is carried out via the supply circuit. This supply step is preferably carried out by transferring liquid hydrogen, using the first supply line of the supply circuit, from the first source of liquid hydrogen to the first shell of the tank 100.

It should be noted that a step of supplying requesting elements can be carried out via the supply line at any time during the method, in particular simultaneously or not with the implementation of one or more steps of the method according to the invention. This supply step can be carried out several times during the method according to the invention.

After the supply step, a thermodynamic equilibrium is established in the tank 100 to have an identical pressure between the gaseous fraction 1004 and the liquid fraction 1002. Heat exchange generally takes place in the tank 100 resulting in heating of the liquid fraction 1002. The thermodynamic equilibrium will change as a result. A portion of the liquid fraction 1002 equivalent to the thermal loss then vaporizes. As the facility is in a closed cycle, the gaseous fraction 1004 and the pressure in the tank 100 increase. However, if the increase in the gaseous fraction 1004 and the pressure is too great, it becomes difficult or even impossible to supply the tank 100.

To compensate for these increases in the gaseous fraction 1004 and the pressure, according to the invention, a portion of the liquid fraction 1002 of the fluid is therefore withdrawn, during a withdrawal step, from the tank 100 via the extraction line Cext.

The withdrawal step is preferably carried out after performing a step of measuring a parameter representative of the pressure of the gaseous fraction 1004 and/or a parameter representative of the pressure of the liquid fraction 1002. Depending on one and/or other of these two parameters, the withdrawal step and the subsequent steps are carried out.

After the withdrawal step, a withdrawn portion defined in state A is thus obtained by:
a first temperature T1,
a first pressure P1,
a first enthalpy E1, and
a first density D1.

The withdrawn portion in state A has no gaseous phase and only consists of a liquid phase. In particular, this withdrawn portion then lies on the characteristic liquid saturation curve of the fluid.

In one variant, point A may be far from or substantially close to the characteristic liquid saturation curve of the fluid, while still being in the liquid part.

Using this withdrawal and the steps that follow, the pressure of the gaseous fraction 1004 at the top of the tank 100 is regulated so that this pressure remains less than a predetermined value, for example less than 20 bar, preferably less than 12 bar when the fluid is hydrogen.

Preferably, the withdrawal step is carried out discontinuously. For example, the withdrawal step can be carried out whenever the pressure inside the tank 100 becomes equal or greater than the predetermined value.

Preferably, during this withdrawal step, the flow rate and the volume of the liquid portion of the extracted fluid are determined by the characteristics of the compressor means 120, i.e. by a nominal flow rate.

Then, in a subsequent step, this withdrawn portion is compressed in the compressor means 120. This compression is a substantially isothermal compression resulting in a compressed portion defined in state B by:
a second temperature T2 substantially equal to the first temperature T1,
a second pressure P2 greater than the first pressure P1, and
a second density D2 greater than the first density D1.

Advantageously, the compression step is carried out over a pressure range of between 6 and 100 bar, preferably between 6 and 70 bar when the fluid is hydrogen. It should be noted that the pressure rise associated with this compression is inherent to the characteristics of the compressed fluid.

It should be noted that compression is capable of leading to a decrease in enthalpy between the first enthalpy E1 of state A and a second enthalpy E2 of state B over a predefined pressure range. Compression between state A and state B is essentially isentropic. This decrease in enthalpy is possible because the Joule-Thomson coefficient (in K/bar) is positive for the predefined pressure range, while compression is substantially isothermal. It should be noted that the positive Joule-Thomson coefficient for a liquid-saturated phase is shown by the fact that, for this predefined pressure range, the slope of the curve showing the change in enthalpy (in kJ/kg) based on pressure (in bar) is negative. This compression is irreversible.

Advantageously, the compression step leads to a continuous drop in the enthalpy of the withdrawn portion from state A to state B.

Preferably, the compression step is carried out from state A to state B as long as the characteristic Joule-Thomson coefficient of the fluid is positive. This maximizes the efficiency of the facility.

However, the compression step is advantageously stopped when the drop in enthalpies of the compressed portion is less than 0.1 kJ/kg for a pressure rise of 1 bar. It should be noted that if the compression step continued while the drop in enthalpies was less than 0.1 kJ/kg, it would be difficult to exploit the inflection point of the enthalpy curve at constant temperature without using a large amount of energy.

When the tank 100 is also the expansion means 160 (see [FIG. 1]), the compressed portion then flows through the transfer line C11 which connects the compressor means 120 to the injector means 1008.

When the compressor means 120 is connected directly or indirectly to the expansion means 160 upstream of the injector means 1008 (see FIGS. 2 and 3), the compressed portion then flows through the transfer line C12 which connects the compressor means 120 to the expansion means 160 or through the transfer line C13 which connects the compressor means 120 to the buffer tank 140.

In the case where the compressor means 120 is connected to the buffer tank 140, once the internal pressure of the buffer tank 140 reaches a predetermined pressure and preferably between 6 and 70 bar, the compressed portion which was stored in the buffer tank 140 then flows through the second transfer line C23 which leads to the expansion means 160.

In a subsequent step, the compressed portion then undergoes expansion to obtain an expanded portion defined in state C by:
a third temperature T3 less than the second temperature T2,
a third pressure P3 less than the second pressure P2, and
a third density D3 less than the second density D2 and greater than the first density D1.

According to the implementation of the example embodiment shown in [FIG. 1], expansion takes place during or after a step of injecting the compressed portion into the tank 100, when the tank 100 is also the expansion means. In this case, state C is defined as being the equilibrium state in the tank 100 after injection of the compressed portion therein. Herein, expansion can therefore be initiated during injection and take place in the tank 100.

In this first example embodiment shown in [FIG. 1], the expansion is not isenthalpic. The portion injected into the tank 100 is also defined by a third enthalpy E3 which is less than the first enthalpy E1 of the withdrawn portion. This implies a decrease in the internal temperature of the tank 100 after thermodynamic equilibrium.

According to the example embodiments shown in FIGS. 2 and 3, expansion takes place between the compression step and a subsequent step of injecting the expanded portion into the tank 100 when the facility comprises an expansion means 160 separate from the tank 100. In this case, state C is defined as being the state wherein the expanded portion is found before being injected into the tank 100. The result is a portion leaving the expansion means 160 which has properties that are close to the thermodynamic conditions of the tank 100.

According to the implementation of the example embodiments shown in FIGS. 2 and 3, expansion is preferably isenthalpic. Such isenthalpic expansion has the advantage of not generating heat.

Preferably, in state C, the expanded portion lies substantially on the characteristic liquid saturation curve of the fluid. For example, in state C, P3 can be between P1 and P2, preferably between P1 and the liquid saturation pressure of the fluid plus 0.1 bar. Furthermore, in doing so, injection of the portion to be injected into the tank 100 is facilitated.

The portion injected into the tank 100 is also defined by a third enthalpy E3 which is less than the first enthalpy E1 of the withdrawn portion. This implies a decrease in the internal temperature of the tank 100 after thermodynamic equilibrium. Thus, the portion injected into the tank 100 is, inter alia, defined by a third temperature T3 less than the first temperature T1 so as to compensate for any heating in the tank 100. In doing so, an increase in pressure inside the tank 100 is therefore avoided which would have been unavoidable if the method according to the invention had not been implemented.

### EXAMPLE

The storage facility according to the second example embodiment was implemented with hydrogen as the fluid.

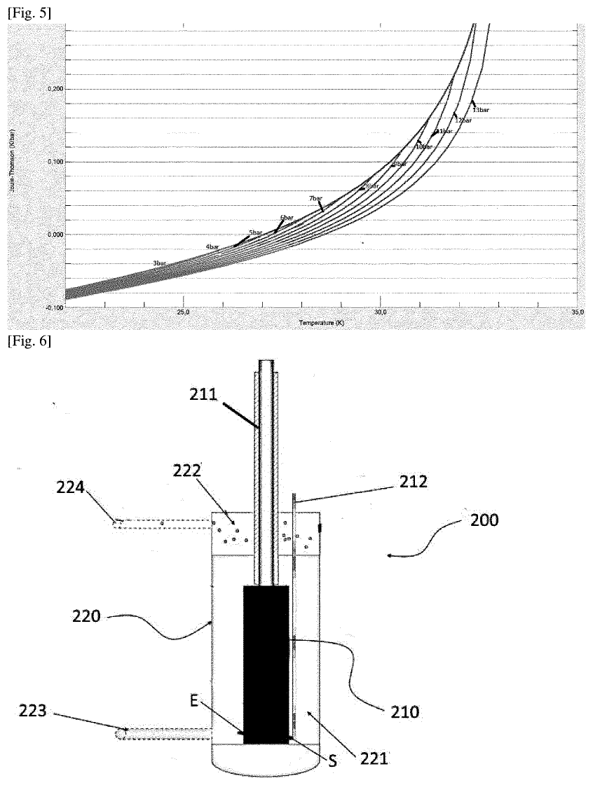

The table of experimental results below can be read in conjunction with the diagram shown in [FIG. 4] and [FIG. 5] with reference to the above-mentioned states A, B and C.

As shown in [FIG. 4], the enthalpy curve at constant liquid hydrogen temperatures approximately equal to 30K has a substantially parabolic shape.

In state B, we are at the inflection point of the enthalpy curve, the inflection point corresponding to an enthalpy minimum over a pressure range of between 8 bar and 30 bar.

As shown in [FIG. 5], for hydrogen, isenthalpic expansion can only be implemented above a pressure of 5 bar at which point the Joules-Thomson coefficient becomes positive.

In particular, the table of experimental results below gives a clearer idea of the advantages of implementing the method in accordance with the invention.

This table shows values for temperatures (in K), pressures (in bar), densities (in kg/m³), volumes (in m³/kg), specific internal energies (kJ/kg) and enthalpies (kJ/kg) of hydrogen initially contained in the tank 100 and then flowing in the above-described facility according to the above-described method according to the invention so as to be found in the above-mentioned states A, B, C and shown in [FIG. 4].

TABLE 1

| | Temperature | Pressure | Density | Volume | Enthalpy |
|---|---|---|---|---|---|
| State | (K) | (bar) | (kg/m³) | (m³/kg) | (kJ/kg) |
| A | 30.2 | 8.5 | 53.37 | 0.019 | 149.02 |
| B | 30.2 | 23 | 60.39 | 0.017 | 138.83 |
| C | 29.8 | 8.5 | 54.93 | 0.018 | 183.83 |

The following conclusions can be drawn from this table. Between states B and C, a substantially isenthalpic expansion has effectively taken place. Furthermore, in state C, the temperature T3 is much less than the temperature T1 defined in state A. In this fashion, the density D3 defined in state C is much greater than the density D1 defined in state A.

Of course, the invention is not limited to the particular examples disclosed and shown in the present application. Other variants or embodiments within the reach of the skilled person may also be envisaged without departing from the scope of the invention, as defined by the claims.

1. A method for controlling the internal pressure of a cryogenic tank (100) containing a liquid fraction (1002) and a gaseous fraction (1004) of a fluid, the enthalpy of which can be lowered during isothermal compression in the liquid phase, the method comprising the following steps:
withdrawal of a portion of the liquid fraction to obtain a withdrawn portion defined in state A by:
a first temperature T1,
a first pressure P1,
a first enthalpy E1, and
a first density D1,
substantially isothermal compression of the withdrawn portion to obtain a compressed portion defined in state B by:
a second temperature T2 substantially equal to the first temperature T1,
a second pressure P2 greater than the first pressure P1, and
a second density D2 greater than the first density D1,
said compression being intended to lead to a decrease in enthalpy between the first enthalpy E1 in state A and a second enthalpy E2 in state B,
expansion of the compressed portion to obtain an expanded portion defined in state C by:
a third temperature T3 less than the second temperature T2,
a third pressure P3 less than the second pressure P2, and
a third density D3 less than the second density D2 and greater than the first density D1,
injection of the compressed portion or of the expanded portion into the tank (100),
said expansion being carried out after the injection step when the compressed portion is injected into the tank (100), or
said expansion being carried out between the compression step and the injection step when the expanded portion is injected into the tank (100).

2. The method according to claim 1, whereby the compression step leads to a continuous drop in the enthalpy of the withdrawn portion from state A to state B.

3. The method according to claim 2, whereby the compression step is stopped when the drop in enthalpy of the compressed portion is less than 0.1 kJ/kg at a pressure rise of 1 bar.

4. The method according to claim 1, whereby the fluid is hydrogen.

5. The method according to one of claims 1 to 4, whereby the third pressure P3 is greater than or substantially equal to the first pressure P1.

6. The method according to one of claims 1 to 5, whereby the expansion is a substantially isenthalpic expansion when this is carried out between the compression step and the injection step.

7. A facility for storing a liquid fraction (1002) and a gaseous fraction (1004) of a fluid configured to implement the method according to any one of claims 1 to 6, the facility comprising:
a cryogenic tank (100) intended to contain the fluid,
a means of withdrawing (1006) a portion of the liquid fraction (1002),
a compressor means (120) comprising a compressor element (210) and a cooling element (220) for the compressor element (210) configured to maintain at temperature the compressor element (210) during compression to achieve substantially isothermal compression of the withdrawn portion to obtain a compressed portion,
an expansion means (160) capable of expanding the compressed portion to obtain an expanded portion, and
an injector means (1008) capable of injecting the compressed portion or the expanded portion into the cryogenic tank (100),
a facility wherein the expansion means (160) and the tank (100) are either combined or separate.

8. The facility according to claim 7, further comprising a buffer tank (140) arranged between the compressor means (120) and the expansion means (160).

9. The facility according to one of claim 7 or 8, wherein the expansion means (160) comprises a throttle valve (162).
